(19) United States
(12) Patent Application Publication
(10) Pub. No.: US 2026/0169621 A1
(43) Pub. Date: Jun. 18, 2026

(54) INTERACTION CONTROL METHOD AND APPARATUS, DEVICE, MEDIUM, AND PROGRAM PRODUCT

(71) Applicant: Beijing Zitiao Network Technology Co., Ltd., Beijing (CN)

(72) Inventors: Xiaochao DUAN, Beijing (CN); Zhao TIAN, Beijing (CN); Bing LI, Beijing (CN); Xuancheng ZHU, Beijing (CN); Yutong LIU, Beijing (CN)

(21) Appl. No.: 19/300,528

(22) Filed: Aug. 14, 2025

(30) Foreign Application Priority Data
Dec. 18, 2024 (CN) 202411876190.3

(51) Int. Cl. G06F 3/0486; G06F 3/04812; G06F 3/04815; G06F 3/04817; G06F 3/14

(52) U.S. Cl. CPC G06F 3/0486; G06F 3/04812; G06F 3/04815; G06F 3/1454; G06F 3/04817; G06F 2203/04803

(57) ABSTRACT

Embodiments of the present disclosure provide an interaction control method, a device and a medium. The method is performed by a controlling device, which is in wireless communication with a controlled device. The method includes: displaying at least two window interfaces in an interaction control scenario, where each window interface corresponds to one screen of the controlled device, and presenting screen content; monitoring an input event generated when an indication cursor of an input device moves from a first window interface to a second window interface, generating input event information of the input event, and sending the input event information to the controlled device, so that the controlled device determines, based on the input event information, that a drag-and-drop operation is performed on a first object; and receiving and displaying image content of the first object being dragged and dropped from a first screen to a second screen.

### CROSS-REFERENCE TO RELATED APPLICATION

This application claims the priority to and benefits of the Chinese Patent Application, No. 202411876190.3, which was filed on Dec. 18, 2024. The aforementioned patent application is hereby incorporated by reference in its entirety.

### TECHNICAL FIELD

Embodiments of the present disclosure relate to the field of computer application technologies, and in particular, to an interaction control method and apparatus, a device, a medium, and a program product.

### BACKGROUND

At present, a controlling device may be used to perform interaction control on a controlled device, and the controlling device may be a virtual reality device different from a traditional electronic device (such as a mobile terminal or a computer), compared with the interaction control of the controlled device by the traditional controlling device. The controlling device provides richer input manners, such as gesture input and handle input, to simulate mouse behavior for remote operation.

With the continuous development of virtual reality technology, it has a multi-window display function. If the controlled device is configured with two or more screens, interface content displayed on each screen may be respectively presented in a plurality of window interfaces provided by the controlling device.

However, in an existing interaction control implementation, the controlling device cannot flexibly implement cross-screen presentation of a manipulated object on the controlled device from one screen to another screen, which affects operation experience of an operator.

### SUMMARY

The present disclosure provides an interaction control method and apparatus, a device, a medium, and a program product to achieve input control flexibility and convenience of a controlling device for a controlled device.

In a first aspect, an embodiment of the present disclosure provides an interaction control method, which is applied to a controlling device, where the controlling device is in wireless communication with a controlled device, the controlled device includes at least two screens, and the method includes: displaying at least two window interfaces in an interaction control scenario, where each window interface corresponds to one screen of the at least two screens of the controlled device, and presenting screen content in a corresponding screen; monitoring an input event generated by an input device, generating input event information of the input event, and sending the input event information to the controlled device, so that the controlled device determines, based on the input event information, that a drag-and-drop operation is performed on a target object (e.g. first object), where the input event is generated when an indication cursor of the input device moves from a first window interface to a second window interface; and receiving and displaying image content fed back by the controlled device, where the image content is that the target object is dragged and dropped from a first screen to a second screen, and the first screen and the second screen correspond to the first window interface and the second window interface, respectively.

In a second aspect, an embodiment of the present disclosure provides an interaction control method, which is applied to a controlled device, where the controlled device is in wireless communication with a controlling device, the controlled device includes at least two screens, and the method includes: sending screen content in each of the at least two screens to the controlling device in an interaction control scenario, to display, on the controlling device, at least two window interfaces, where each of the at least two window interfaces corresponds to one screen, and presents screen content in a corresponding screen; receiving input event information sent by the controlling device, and determining, based on the input event information, that a drag-and-drop operation is performed on a target object, where the input event information is generated by the controlling device by monitoring an input event of an input device; and responding to the drag-and-drop operation, and feeding back image content generated in a response to the drag-and-drop operation to the controlling device, so that the controlling device receives and displays the image content, where the image content is that the target object is dragged and dropped from a first screen to a second screen, and the first screen and the second screen correspond to a first window interface and a second window interface on the controlling device, respectively.

In a third aspect, an embodiment of the present disclosure provides an interaction control apparatus, which is configured on a controlling device, where the controlling device is in wireless communication with a controlled device, the controlled device includes at least two screens, and the apparatus includes: a window display module, configured to display at least two window interfaces in an interaction control scenario, where each window interface corresponds to one screen of the at least two screens of the controlled device, and present screen content in a corresponding screen; an information sending module, configured to monitor an input event generated by an input device, generate input event information of the input event, and send the input event information to the controlled device, so that the controlled device determines, based on the input event information, that a drag-and-drop operation is performed on a target object, where the input event is generated when an indication cursor of the input device moves from a first window interface to a second window interface; and a content display module, configured to receive and display image content fed back by the controlled device, where the image content is that the target object is dragged and dropped from a first screen to a second screen, and the first screen and the second screen correspond to the first window interface and the second window interface, respectively.

In a fourth aspect, an embodiment of the present disclosure provides an interaction control apparatus, which is configured on a controlled device, where the controlled device is in wireless communication with a controlling device, the controlled device includes at least two screens, and the apparatus includes: a content sending module, configured to send screen content in each of the at least two screens to the controlling device in an interaction control scenario, to display, on the controlling device, at least two window interfaces, where each of the at least two window interfaces corresponds to one screen, and presents screen content in a corresponding screen; an information receiving module, configured to receive input event information sent by the controlling device, and determine, based on the input event information, that a drag-and-drop operation is performed on a target object, where the input event information is generated by the controlling device by monitoring an input event of an input device; and an operation response module, configured to respond to the drag-and-drop operation, and feed back image content generated in the response to the drag-and-drop operation to the controlling device, so that the controlling device receives and displays the image content, where the image content is that the target object is dragged and dropped from a first screen to a second screen, and the first screen and the second screen correspond to a first window interface and a second window interface on the controlling device, respectively.

In a fifth aspect, an embodiment of the present disclosure provides a virtual reality device, including: one or more input devices; one or more processors; and a storage apparatus, configured to store one or more programs, where the one or more programs are executed by the one or more processors, so that the one or more processors implement the interaction control method provided in the first aspect above in the embodiment.

In a sixth aspect, an embodiment of the present disclosure provides an electronic device, including: one or more processors; and a storage apparatus, configured to store one or more programs, where the one or more programs are executed by the one or more processors, so that the one or more processors implement the interaction control method provided in the second aspect above in the embodiment.

In a seventh aspect, an embodiment of the present disclosure provides a storage medium including computer-executable instructions, where the computer-executable instructions, when executed by a computer processor, are configured to perform the interaction control method according to any embodiment of the present disclosure.

In an eighth aspect, an embodiment of the present disclosure provides a computer program product, where the computer program product includes a computer program, and the computer program, when executed by a processor, implements the interaction control method according to any embodiment of the present disclosure.

The embodiments of the present disclosure provide an interaction control method and apparatus, a device, a medium, and a program product. The method relates to interaction control between a controlling device and a controlled device. The controlling device is in wireless communication with the controlled device, and the controlled device includes at least two screens. The controlling device first displays at least two window interfaces in an interaction control scenario, where each window interface corresponds to one screen of the controlled device, and presents screen content in the corresponding screen; then monitors an input event generated by an input device, generates input event information of the input event, and sends the input event information to the controlled device, so that the controlled device determines, based on the input event information, that a drag-and-drop operation is performed on a target object, where the input event is generated when an indication cursor of the input device moves from a first window interface to a second window interface; and finally receives and displays image content fed back by the controlled device, where the image content is that the target object is dragged and dropped from a first screen to a second screen, and the first screen and the second screen correspond to the first window interface and the second window interface, respectively. According to the technical solutions of the embodiments, the controlling device, as an input event generation end of the controlled device, may provide an operation event for interaction control for the controlled device, so that the controlled device may parse operation logic corresponding to the operation event and execute the operation logic, and an execution result of the operation logic may be displayed on the controlling device, so that the controlling device displays the same screen content as the controlled device. Compared with the prior art, the technical solutions of the embodiments may achieve continuous reception of input events generated by the input device by the controlling device, and the reception of the input events will not be interrupted when the input device is moved out of one window to another window. The continuous reception of the input events generated across the windows ensures that the controlled device may also continuously respond to operation instructions corresponding to the input events, thereby ensuring cross-screen drag-and-drop control of the manipulated object on the controlled device by the controlling device, simplifying the existing cross-screen drag-and-drop that requires multiple interactions to achieve, improving input control flexibility of the controlling device, and also improving operation experience of the operator.

### BRIEF DESCRIPTION OF DRAWINGS

The above and other features, advantages, and aspects of the embodiments of the present disclosure become more apparent with reference to the following specific implementations and in conjunction with the drawings. Throughout the drawings, the same or similar reference numerals denote the same or similar elements. It should be understood that the drawings are schematic and that parts and elements are not necessarily drawn to scale.

FIG. 1a and FIG. 1b are diagrams showing effects of cross-screen dragging of a manipulated object in an existing interaction control implementation;

FIG. 2a is a schematic flowchart of an interaction control method according to an embodiment of the present disclosure;

FIG. 2b is a diagram showing an effect of cross-screen dragging in an interaction control method according to an embodiment of the present disclosure;

FIG. 3 is a schematic flowchart of an interaction control method according to an embodiment of the present disclosure;

FIG. 4 is a schematic diagram of a structure of an interaction control apparatus according to an embodiment of the present disclosure;

FIG. 5 is a schematic diagram of a structure of an interaction control apparatus according to an embodiment of the present disclosure;

FIG. 6 is a schematic diagram of a structure of a virtual reality device according to an embodiment of the present disclosure; and

FIG. 7 is a schematic diagram of a structure of an electronic device according to an embodiment of the present disclosure.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein; on the contrary, these embodiments are provided for a more thorough and complete understanding of the present disclosure. It should be understood that the drawings and embodiments of the present disclosure are only for exemplary purposes and are not intended to limit the protection scope of the present disclosure.

It should be understood that steps described in method implementations of the present disclosure may be performed in different orders and/or in parallel. Furthermore, the method implementations may include additional steps and/or omit performing the illustrated steps. The scope of the present disclosure is not limited in this respect.

The term “include/comprise” and its variants used herein are open-ended inclusions, that is, “include/comprise but not limited to”. The term “based on” is “at least partially based on”. The term “an embodiment” means “at least one embodiment”; the term “another embodiment” means “at least one other embodiment”; and the term “some embodiments” means “at least some embodiments”. Related definitions of other terms are given in the description below.

It should be noted that concepts such as “first” and “second” mentioned in the present disclosure are only used to distinguish different apparatuses, modules, or units, and are not used to limit an order or interdependence of functions performed by these apparatuses, modules, or units.

It should be noted that modifiers of “a” and “a plurality of” mentioned in the present disclosure are schematic rather than restrictive, and those skilled in the art should understand that unless otherwise explicitly specified in the context, they should be understood as “one or more”.

The names of messages or information exchanged between a plurality of apparatuses in the implementations of the present disclosure are only for illustrative purposes, and are not intended to limit the scope of these messages or information.

It may be understood that before using the technical solutions disclosed in the embodiments of the present disclosure, the user should be informed of the type, range of use, use scenarios, etc., of personal information involved in the present disclosure and the authorization of the user should be obtained in an appropriate manner in accordance with relevant laws and regulations.

For example, in response to receiving an active request from a user, prompt information is sent to the user to clearly prompt the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, for example, a manner of sending the prompt information to the user may be a manner of a pop-up window, and the prompt information may be presented in the pop-up window in text. In addition, the pop-up window may further carry a selection control for the user to select “agree” or “disagree” to provide the personal information to the electronic device.

It may be understood that the above process of notifying and obtaining user authorization is only schematic and does not constitute a limitation on the implementations of the present disclosure, and other manners that satisfy the relevant laws and regulations may also be applied to the implementations of the present disclosure.

It may be understood that data involved in the technical solutions (including but not limited to the data itself, acquisition or use of the data) should comply with requirements of corresponding laws, regulations, and related provisions.

It should be noted that an application scenario involved in this embodiment may be described as follows: in a scenario where a virtual reality device is in wireless communication with a computer, the virtual reality device, as a controlling device, may perform input control on the computer, as a controlled device. This is equivalent to achieving input of a control instruction for screen content of the computer through the virtual reality device. When the virtual reality device has a multi-window display function, if the computer has a plurality of screens, the virtual reality device may use the multi-window function to display screen content of each screen through a window interface.

It is assumed that the screen content of each screen of the computer has been displayed in each window interface of the virtual reality device. When an operator controls the screen content of the computer through the virtual reality device and specifically wants to achieve cross-screen dragging of a controlled object on one screen of the computer to another screen, the operator needs to operate the controlled object at least twice using an existing interaction control method. In one operation, the controlled object is dragged from its initial position on a first screen to an edge of the first screen. If all content of the controlled object is still within the first screen after dragging, the controlled object needs to be dragged again on the first screen to enable a portion of the content of the controlled object to fall into a second screen. Then, the controlled object that has fallen into the second screen needs to be at least dragged on the second screen to ensure that all the content of the controlled object falls into the second screen.

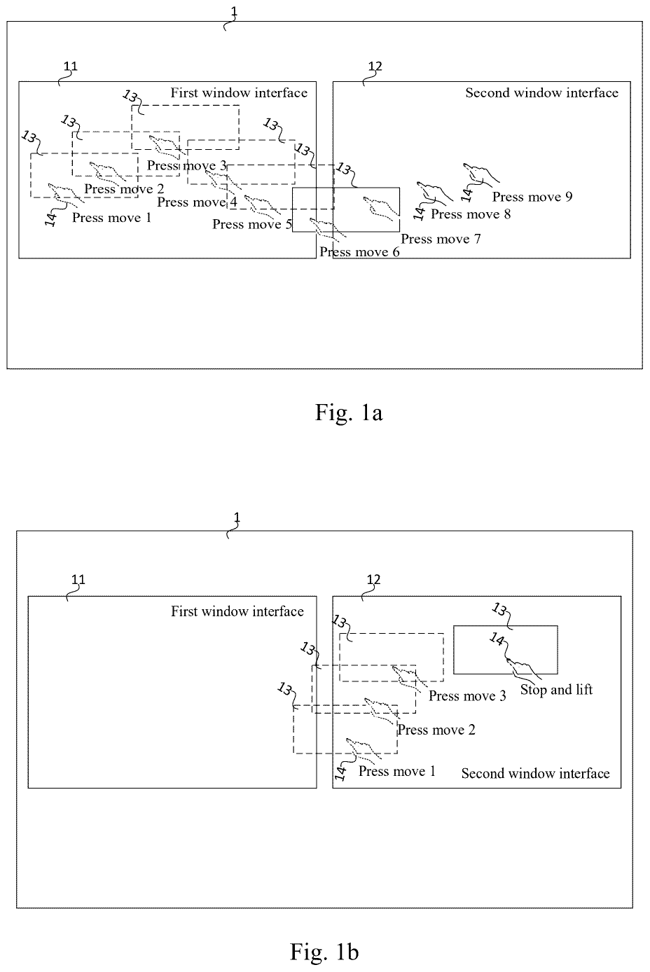

Exemplarily, FIG. 1a and FIG. 1b are diagrams showing effects of cross-screen dragging of a manipulated object in an existing interaction control implementation. FIG. 1a and FIG. 1b are displayed and described from the perspective of a virtual reality device. FIG. 1a and FIG. 1b show a virtual display screen 1 of the virtual reality device. Two window interfaces are displayed in the virtual display screen 1, which are a first window interface 11 and a second window interface 12, respectively. The figures further show a controlled object 13 as an interaction control object. In the existing implementation of interaction control, in an implementation of dragging the controlled object 13 across the windows from the first window interface 11 (corresponding to a first screen of the computer) to the second window interface 12 (corresponding to the first screen of the computer) in an input form of a gesture 14, after performing at least one press move on the controlled object 13, an effect shown in FIG. 1a is first presented, that is, only a portion of an area of the controlled object 13 falls into the second window interface 12.

Thereafter, if the gesture 14 remains in the press-move state and a press-lift operation is not performed, due to the limitation of the existing interaction control implementation, the virtual reality device no longer continues to recognize the press move, and therefore, no matter how the gesture 14 is moved in the second window interface 12, the controlled object 13 always remains in the state shown in FIG. 1a, that is, a portion of the area of the controlled object remains in the first window interface 11, and the other portion of the area remains in the second window interface 12 and does not continue to move to the second window interface.

If the controlled object needs to be completely dragged to the second window interface, a press-lift event needs to be first generated through the gesture 14, and then the gesture 14 is applied to a portion of the area of the controlled object in the second window interface 12, and a press-move event is generated again. The press-move event generated again in the second window interface after the gesture 14 stops moving and is lifted may be received and recognized by the virtual reality device, and the dragging of the controlled object 13 may be responded to again through the press-move event received again, so that the area of the controlled object that remains in the first window interface may be completely dragged into the second window interface 12, presenting the effect shown in FIG. 1b.

It may be learned that the existing interaction control cannot flexibly achieve cross-screen dragging of the controlled object, and the implementation process is relatively complicated, which affects the operation experience of the operator.

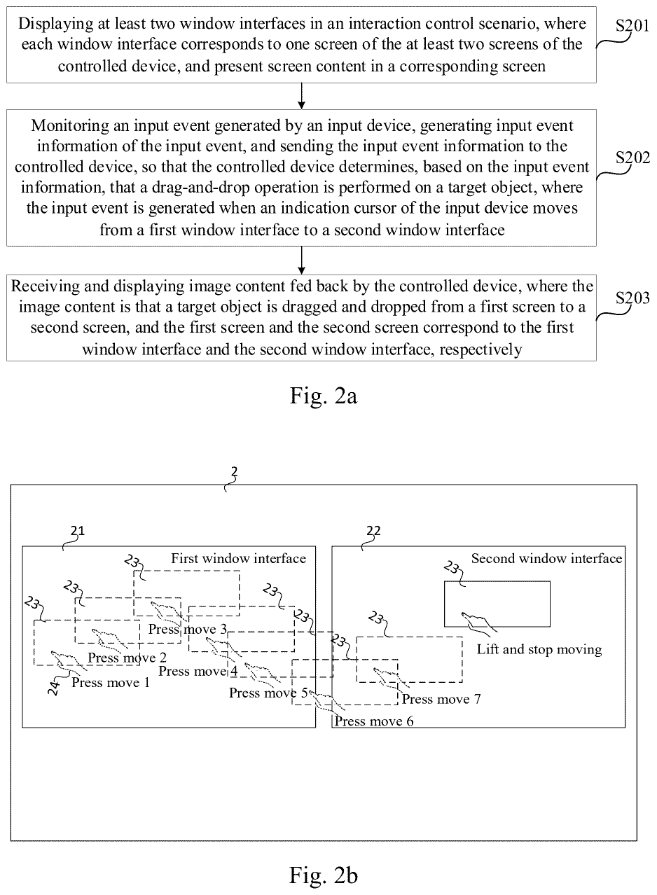

Based on this, FIG. 2a is a schematic flowchart of an interaction control method according to an embodiment of the present disclosure. This embodiment may be applied to a case of performing interaction control with a controlled device. The method may be performed by an interaction control apparatus. The apparatus may be implemented in software and/or hardware, and may be configured in an electronic device as a controlling device. The electronic device may be preferably a virtual reality device.

The controlling device may establish a wireless connection with the controlled device, and the controlled device includes at least two screens. As shown in FIG. 2a, the interaction control method provided in this embodiment may include the following steps.

S201: displaying at least two window interfaces in an interaction control scenario, where each window interface corresponds to one screen of the at least two screens of the controlled device, and present screen content in a corresponding screen.

In this embodiment, it may be considered that after the controlling device establishes the wireless connection with the controlled device, the controlling device is triggered to perform interaction control on the controlled device, and therefore, the controlling device is considered to enter the interaction control scenario. In addition, the interaction control involved in this embodiment may be considered as an implementation description of interaction control after the controlling device enters the interaction control scenario.

This step may be considered as a related presentation when no input control is performed after the controlling device enters the interaction control scenario, and specifically may be an implementation of displaying screen content of the controlled device on a display apparatus of the controlling device. It should be understood that in this embodiment, it is preferably considered that the controlling device has a multi-window display function. When the controlled device has at least two screens, the controlling device may display at least two window interfaces through this step to respectively present screen content of each of the screens of the controlled device.

It should be noted that when the controlling device is a virtual reality device, a display apparatus thereof may be considered as a virtual display screen, and each window interface may be displayed on the virtual display screen.

S202: monitoring an input event generated by an input device, generating input event information of the input event, and sending the input event information to the controlled device, so that the controlled device determines, based on the input event information, that a drag-and-drop operation is performed on a target object, where the input event is generated when an indication cursor of the input device moves from a first window interface to a second window interface.

In this embodiment, the input device may be considered as a device that is accessed by the active device and that is used to perform an information operation event, and the input device may be a keyboard, a mouse, a touchpad, etc., or may be a handle, a gesture, etc.

It should be noted that a generic input reception function for monitoring an input event generated by the input device is built in an operating system on which the controlling device depends. However, the generic input reception function has a limitation in that the generic input reception function may ensure normal reception of input events generated by the input device only when the controlling device is in a normal application scenario. When the controlling device is in the interaction control scenario, each of the window interfaces displayed by the controlling device represents a plurality of screens of the controlled device. In this case, the generic input reception function originally configured by the controlling device only allows reception of a press-move event generated in any one of the window interfaces. If the input device is moved out of the window interface in a process of generating the press-move event, the generic input reception function terminates reception of subsequent press-move events generated by the input device.

Based on the above functional limitation of the generic input reception function, it may be learned that the generic input reception function cannot receive all press-move events generated in a scenario across window interfaces. This is equivalent to that the controlling device cannot monitor a complete press-move event in the scenario where the press move is performed across the window interfaces, which results in that the slave terminal cannot give a complete press-move operation response based on the complete press-move event.

Therefore, it may be learned from the above description that if the controlled device needs to achieve the cross-screen drag-and-drop operation based on the press-move event of the controlling device, it is necessary to ensure that the controlling device monitors a complete press-move event in the scenario where the press move is performed across the window interfaces. In this embodiment, through this step, complete monitoring of the input event generated by the input device in the interaction control scenario may be achieved. Even if the indication cursor of the input device is moved from the first window interface to the second window interface in the process of generating the input event, through this step, the input event generated by the input device in the first window interface and the input event generated by the input device in the second window interface may be respectively monitored.

Specifically, one manner of implementing monitoring of the input event of the input device in this step may be described as follows: through an input reception function additionally constructed in the dependent operating system with respect to the interaction control scenario, continuous monitoring of the input event generated by the input device may be achieved. The input reception function used in this embodiment may be considered as being specially constructed with respect to the interaction control scenario, and reception of each input event is redefined in the input reception function, and a receivable region is not limited by each window interface.

In this embodiment, it is further necessary to generate corresponding input event information for the monitored input event through this step. The input event information may be considered as information that describes an event attribute feature of the input event. The input event information may be used to give a response to the input event at a software level, and is also information on which the controlled device depends to respond to the input event.

It should be noted that the input device is often an external hardware device of the controlling device, and an input event transmitted by the input device to the controlling device is often represented in a format compatible with the input device, and event information represented by each input event cannot be directly recognized by the operating system on which the controlling device depends.

Therefore, an implementation of generating the input event information for the input event in this step may be described as follows: first, event attribute information carried when the input device generates the input event is obtained, and then, through preset event mapping information for converting a data format involved in hardware data into a software readable format involved in the operating system, event description information corresponding to the event attribute information at the software level may be determined, and the event description information may be determined as the input event information of the input event.

In addition, in this step, the generated input event information may also be sent to the controlled device, to implement input control of the controlling device over the controlled device through the sent input event information.

Further, in this embodiment, the controlling device may be preferably a virtual reality device; the input device may be preferably a handle, and the indication cursor may be a handle ray; or the input device is a gesture detection device, and the indication cursor is a gesture icon; or the input device is a mouse, and the indication cursor is a mouse arrow.

The virtual reality device is usually presented in a form of head-mounted or glasses in actual application. The paired input device may be a handle, and after the handle is accessed to the virtual reality device, an indication cursor in a style of a handle ray may be presented on a virtual display screen of the virtual reality device. The paired input device may also include a gesture, that is, a camera or an infrared apparatus is used to sense a hand of the player, an input mapping with the hand is established, and a gesture icon corresponding to the hand may be presented on the virtual display screen as the indication cursor. In addition, the paired input device may also be a Bluetooth mouse, and an indication cursor of a mouse arrow may be presented corresponding to the Bluetooth mouse.

It should be understood that when the input device generates an input event of moving or pressing and moving, a position of the indication cursor of the input device changes with the movement, and therefore, there is a case where the indication cursor of the input device moves from the first window interface to the second window interface.

S203: receiving and displaying image content fed back by the controlled device, where the image content is that the target object is dragged and dropped from a first screen to a second screen, and the first screen and the second screen correspond to the first window interface and the second window interface, respectively.

It should be noted that the control of the controlled device by the controlling device is mainly implemented by generating an input event, generating input event information, and sending the input event information to the controlled device. In addition, the controlling device may also serve as a synchronous display end of the controlled device. While the controlled device performs a logical operation involved in the input event, image information corresponding to the logical operation may also be synchronously fed back to the controlling device, so that the screen content on the controlled device may be synchronously displayed on the controlling device in real time.

In this embodiment, the input event information sent to the controlled device may be recognized by the controlled device, so that it is determined, based on the input event information sent by the controlling device, that the drag-and-drop operation is actually performed on the target object, and specifically, the drag-and-drop operation of dragging the target object from the first screen to the second screen is performed; and then the controlled device may respond to the drag-and-drop operation, presenting the image content of the target object being dragged from the first screen to the second screen.

To ensure real-time presentation of the image content of the controlled device on the controlling device, in this step, the image content generated by the controlled device in a process of responding to the drag-and-drop operation may be received in real time and displayed in real time. The image content presents a process of the target object being dragged from the first screen to the second screen on the controlled device. It may be learned from the above description that the first screen corresponds to the first window interface, and the second screen corresponds to the second window interface, and accordingly, a process of the target object being dragged from the first window interface to the second window interface may be displayed on the controlling device.

According to the technical solutions of this embodiment, all input events generated when the indication cursor of the input device moves from the first window interface to the second window interface are completely monitored through S202, and therefore, the input event information generated for the input events and sent to the controlled device also has integrity accordingly, which ensures coherence of the movement of the target object from the first screen to the second screen, and is equivalent to flexibly achieving the cross-screen drag-and-drop operation of the manipulated object. Compared with the prior art, the technical solutions of this embodiment may achieve continuous reception of the input events generated by the input device by the controlling device, and the reception of the input events will not be interrupted when the input device is moved out of one window to another window. The continuous reception of the input events generated across the windows ensures that the controlled device may also continuously respond to the operation instructions corresponding to the input events, thereby ensuring the cross-screen drag-and-drop control of the manipulated object on the controlled device by the controlling device, simplifying the existing cross-screen drag-and-drop that requires multiple interactions to achieve, improving the input control flexibility of the controlling device, and also improving the operation experience of the operator.

As a first optional embodiment of this embodiment, based on the above embodiment, monitoring an input event generated by an input device and generating input event information of the input event may be further optimized as the following steps.
a1) monitoring, by calling an input reception function, an indication cursor of the input device, where the input reception function is constructed in an operating system on which the controlling device depends, and the input reception function is constructed in association with the interaction control scenario.

It should be understood that the first optional embodiment provides an implementation of monitoring the input event and an implementation of generating the input event information. The first optional embodiment may be used to implement a monitoring logic of the input event. Specifically, the input reception function pre-constructed in the operating system on which the controlling device depends may be called through this step. The input reception function may be considered as an input function that is independent of a generic input function originally provided by the operating system and that is additionally constructed with respect to the interaction control scenario.

Further, the input reception function is constructed in a function library of the operating system, and the input reception function defines a code description for establishing an association with the interaction control scenario; and the input reception function is called and started to run through a set input call interface after the wireless connection is established.

In this embodiment, through the related code description that constitutes the input reception function, the input reception function may be called and triggered to start running after the controlling device establishes the wireless connection with the controlled device. The input reception function may be called through the input call interface constructed in the dependent operating system. The operating system on which the controlling device depends in this embodiment may be preferably an Android system.

In this step, after the input reception function that has been started to run is called, the indication cursor of the input device may be monitored, and whether the input device generates a movement event or generates a press event and a movement event may be determined by monitoring a position change of the indication cursor.
b1) receiving a first input event generated by the input device when the indication cursor is in the first window interface.

In this embodiment, in this step, a position where the indication cursor is initially located may be analyzed, and then it may be determined that the input device generates the input event when it is monitored that the indication cursor moves or is pressed and moves, and the generated input event may be received. The input event is recorded as the first input event in this embodiment. The first input event may be a movement event or a movement event in the press state. The specific event of the first input event may be determined based on event attribute information carried by the first input event.
c1) receiving continuously a second input event generated by the input device when the indication cursor is moved out of the first window interface to the second window interface.

In this embodiment, through monitoring of the indication cursor in the above step, it may also be determined that the position of the indication cursor changes, and specifically, the indication cursor is moved out of the first window interface and then moved into the second window interface. In this case, reception of an input event generated by the input device in the second window interface may be continued through the input reception function, and the input event may be recorded as the second input event in this embodiment.

The technical solutions of this embodiment provide a complete reception implementation of acquiring an output event generated when the input device is moved from one window interface to another window interface. Different from the prior art in which only an input event generated in one window interface may be received, the above solution in this embodiment better ensures the integrity of the received input event, and also ensures simplification of an operation event at an operation level. This embodiment provides basic data support for subsequent flexible cross-screen dragging of the controlled object.

As a second optional embodiment of this embodiment, based on the above embodiments, generating input event information of the input event may be further optimized as the following steps.
a2) acquiring event attribute information corresponding to the input event, where the event attribute information includes: original event input coordinates and a press state.

It should be understood that the second optional embodiment may be used to implement a generation logic of the input event information involved in the input event. Specifically, the event attribute information generated when the input device generates the input event may be acquired through this step. The event attribute information may include the press state when the input device generates the input event and the original event input coordinates. The original event input coordinates may be considered as coordinate information on a display screen corresponding to the controlling device, and a coordinate system of the display screen is used for coordinate marking.

It should be noted that the event attribute information formed when the input device generates the input event may further include information such as an input device type, a device quiet identification, and an event generation timestamp. With the included information, it may be clearly known which input device generates the input event this time, and it may be more specifically known which input key of the input device generates the input event, and at which specific time point the input event is generated. The included information may also be used to further determine the operation event, thereby ensuring the accuracy of operation event determination.
b2) determining the input event information corresponding to the input event based on preset first event mapping information and the event attribute information.

It may be learned from the above description that the event attribute information acquired in the above step may be considered as event information formed in a format recognizable by the input device, and the input device, as an external device, cannot directly recognize, through the event attribute information generated by the input device, the operating system on which the controlling device depends. Based on this, in the optional embodiment, the event attribute information may be converted through this step, to obtain the input event information recognizable by the operating system.

The first event mapping information may be considered as information that maps a data format involved in the input device to a readable format of the operating system. The event mapping information is preferably recorded as the first event mapping information in this embodiment, and the first event mapping information includes mapping conversion between the input device and the operating system.

Specifically, in the optional embodiment, as an implementation, determining the input event information corresponding to the input event based on preset first event mapping information and the event attribute information may be optimized as the following steps:
b21) determining an operation event represented by the input event based on the original event input coordinates and the press state.

In this embodiment, it may be learned that each input event corresponds to original event input coordinates and a press state, and after a certain number of input events are monitored, whether the input event includes a movement operation may be determined based on whether the original event input coordinates of the monitored input event change, and whether a press operation is performed may also be determined based on the press state of the input event. In this step, a corresponding operation event may be determined for the input event through the above determination, and the operation event may be pressing, moving, or pressing and moving.
b22) generating event description information of the operation event based on the first event mapping information, and using the event description information as the input event information.

In this embodiment, after it is determined, through the above step, the operation event actually included in the input event generated by the input device, the event description information recognizable at the software level of the operating system may be generated for the operation event based on the first event mapping information. The event description information is equivalent to describing an event attribute of the input event at the software level, and also carries information for describing the input event, such as the original event input coordinates and the press state. In this step, the formed event description information may be finally determined as the input event information.

It should be noted that based on the fact that the event attribute information includes the input device type, the device key identification, and the event generation timestamp, the above information converted into the event description information may be carried in the formed input event information, and the above information is sent to the controlled device, which may ensure more accurate parsing of the input event.

The technical solutions of this embodiment provide an implementation of generating the input event information, and the generated input event information provides basic data support for subsequent input control of the controlled device.

To be better understood the interaction effect brought by the interaction control method provided in this embodiment, FIG. 2b is a diagram showing an effect of cross-screen dragging in an interaction control method according to an embodiment of the present disclosure. As shown in FIG. 2b, it may also be considered to display and describe from the perspective of a virtual reality device. Specifically, a virtual display screen 2 corresponding to the virtual reality device is shown. Two window interfaces are also shown in the virtual display screen 2, which are a first window interface 21 and a second window interface 22, respectively. The figure further shows a controlled object 23 as an input control object. It may be seen that the controlled object 23 is initially presented in the first window interface 21.

When interaction control is implemented by using the interaction control method provided in this embodiment, an input event generated by an input device may be continuously monitored. Therefore, in an implementation of dragging the controlled object 23 across the windows from the first window interface 21 to the second window interface 22, all input events (press-move events) generated when an indication cursor 24 (a gesture diagram) of the input device moves from the first window interface 21 to the second window interface 22 may be continuously received. Therefore, input event information of all the input events may also be determined and sent to the controlled device to respond to the input control of the controlling device. The controlled device may parse each piece of input event information, to determine that a drag-and-drop operation is performed on the controlled object 23. Meanwhile, the virtual reality device may also synchronously receive image content generated by the controlled device in a process of responding to the drag-and-drop operation, and display the effect shown in FIG. 2a in real time, which is equivalent to displaying an interaction control effect of dragging the controlled object 23 into the second window interface through one drag-and-drop operation.

Different from the prior art in which the controlled object needs to be dragged multiple times to be dragged to another window interface, the interaction control method provided in this embodiment achieves interaction control of the controlled object more conveniently and flexibly, which effectively improves operation experience of the operator when performing input control.

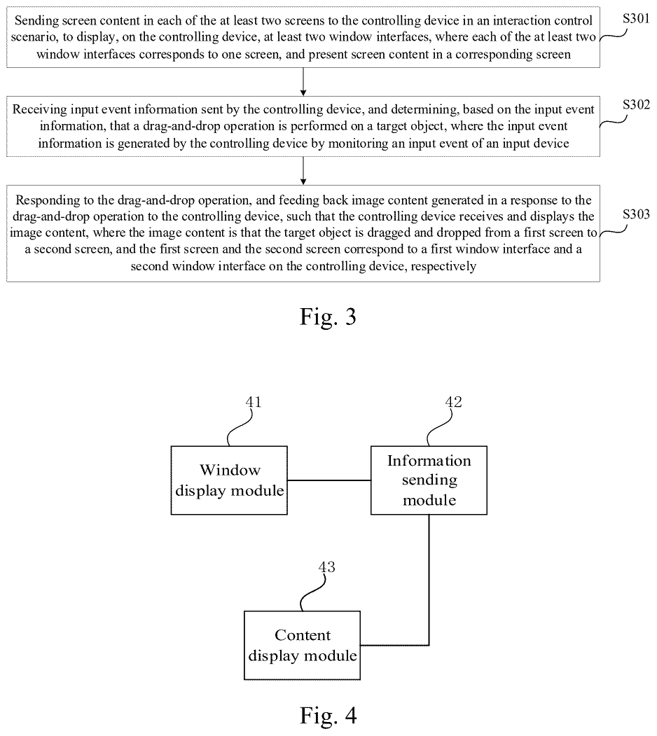

FIG. 3 is a schematic flowchart of an interaction control method according to an embodiment of the present disclosure. This embodiment of the present disclosure is applied to a case of performing interaction control with a controlling device. The method may be performed by an interaction control apparatus. The apparatus may be implemented in the form of software and/or hardware, and optionally, may be configured in an electronic device as a controlled device. The electronic device may be a mobile terminal, a PC, a server, etc.

The controlled device may establish a wireless connection with the controlling device, and at least two screens may be configured on the controlled device as the execution body of this embodiment. As shown in FIG. 3, the interaction control method provided in this embodiment may include the following steps.

S301: sending screen content in each of the at least two screens to the controlling device in an interaction control scenario, to display, on the controlling device, at least two window interfaces, where each of the at least two window interfaces corresponds to one screen, and present screen content in a corresponding screen.

In this embodiment, it may be considered that after the controlled device establishes the wireless connection with the controlling device, it is equivalent to authorizing the controlling device to perform input control and synchronous display on the controlled device, and it may also be considered that the controlled device also enters the interaction control scenario. In this embodiment, after entering the interaction control scenario, the controlled device may respond to interaction control of the controlling device on the controlled device, and therefore, it is considered that interaction control logic involved in the controlled device is implemented after entering the interaction control scenario.

This step may be considered as a related presentation of synchronizing the screen content on the available screen to the controlling device for display, before a new input control sent by the controlling device is received, after entering the interaction control scenario. Specifically, in this step, the screen content on each screen may be respectively sent to the controlling device, and the controlling device may receive the screen content of each screen and respectively display the screen content on a window interface corresponding to the screen.

S302: receiving input event information sent by the controlling device, and determining, based on the input event information, that a drag-and-drop operation is performed on a target object, where the input event information is generated by the controlling device by monitoring an input event of an input device.

It should be understood that in an existing interaction control implementation, because reception of a press-move event by the controlling device is limited to one window interface, if the press-move event generated by the input device occurs across windows, the controlling device may only receive an input event generated in a first window interface, and after the indication cursor of the input device is moved out of the window interface, an input event generated after the indication cursor falls into a second window interface is terminated. Therefore, this is equivalent to that the input event received by the controlling device is incomplete in a process of the indication cursor of the input device moving across the windows.

Considering that the controlled device responds to interaction control logic based on an input event received by the controlling device, the controlled device cannot perform complete interaction control logic based on the received input event information on the premise that the controlling device cannot receive a complete input event. Therefore, the problem that the controlled object cannot cross the screen through one drag-and-drop operation occurs.

With the interaction control method provided for the controlling device in this embodiment, it may be ensured that the controlling device may also achieve continuous reception of input events in the case where the input device moves across the windows to generate input events, so that all input events generated when the input device moves across the windows may be received, thereby ensuring the integrity of the received input events.

Meanwhile, the controlling device may further generate input event information for each received input event and send the input event information to the controlled device. The controlled device may receive the input event information of each input event through this step, and then determine, by analyzing the input event information, that the drag-and-drop operation is performed on the target object. It may be considered that the input event involved in the drag-and-drop operation performed on the target object is monitored and acquired by the controlling device, and the input event information is generated accordingly.

Specifically, an implementation of determining that the drag-and-drop operation is performed on the target object may be described as follows: determining, by analyzing the input event information, input event screen coordinates corresponding to the input event on one screen of the controlled device and an operation event corresponding to the input event screen coordinates; when it is determined that the operation event is press move, determining a start position and an end position of the press move and the target object involved in the press move; and when the start position is on the first screen, the target object is also on the first screen, and the end position is on the second screen, determining that the drag-and-drop operation from the first screen to the second screen is performed on the target object.

It should be noted that the input event information received by the controlled device is described in a description manner recognizable by the controlling device or associated with the controlling device, but the input event information in such a description manner may not be directly recognizable by the controlled device. Therefore, event mapping information may be used to perform conversion on the input event information, to obtain device event description information recognizable by the controlled device.

S303: responding to the drag-and-drop operation, and feeding back image content generated in a response to the drag-and-drop operation to the controlling device, so that the controlling device receives and displays the image content, where the image content is that the target object is dragged and dropped from a first screen to a second screen, and the first screen and the second screen correspond to a first window interface and a second window interface on the controlling device, respectively.

It should be understood that after determining, through the above step, that the interaction control involved in the input event information involves the drag-and-drop operation, and specifically involves the drag-and-drop operation of dragging the target object from the first screen to the second screen, the controlled device may respond to the drag-and-drop operation through this step, to present, in response to the drag-and-drop operation, the image content of the target object being dragged from the first screen to the second screen. The image content may be synchronously fed back to the controlling device, to display, on the controlling device, an image of the target object being dragged from the first window interface to the second window interface. The first window interface corresponds to the first screen, and the second window interface corresponds to the second screen.

The interaction control method provided in this embodiment specifically provides a real-time response process of a press-move event when the controlled device side performs press move across the windows through the controlling device side. In the above embodiments, it is ensured that the controlling device may continuously receive input events generated across the windows without interrupting the reception of the input events when the input device is moved out of one window to another window. On this basis, it is ensured that the controlled device may also continuously respond to operation instructions corresponding to the input events, thereby ensuring cross-screen drag-and-drop control of a manipulated object on the controlled device by the controlling device, simplifying the existing cross-screen dragging that requires multiple interactions to achieve, improving input control flexibility of the controlling device, and also improving operation experience of an operator.

As a third optional embodiment of this embodiment, based on the above embodiments, determining, based on the input event information, that a drag-and-drop operation is performed on the target object may be further specified as the following steps:
a3) converting, based on preset second event mapping information, the input event information into parsable device event description information.

In this embodiment, the second event mapping information may be specifically understood as information that maps a data description format involved in interaction control of the controlling device to a parsable format involved in interaction control of the controlled device. In this embodiment, matching mapping conversion information may be found through the second event mapping information, and the input event information is converted into the parsable device event description information through the mapping conversion information.

It may be considered that event-related information included in the device event description information is basically the same as the input event information, except for a representation form. Therefore, through the device event description information, a press state of the input event generated by the controlling device, the original event input coordinates, etc. may be determined. Meanwhile, based on relevant mapping information in the second event mapping information about a screen on the controlling device side and a screen on the controlled device side, event input screen coordinates on the controlled device corresponding to the original event input coordinates may be determined.
b3) parsing the device event description information, determining an operation event corresponding to the input event as press move, and acquiring event input screen coordinates involved in the press move.

In this embodiment, the device event description information is parsed, and it may be determined whether the operation event corresponding to the input event is press move based on the press state and the event input screen coordinates included in the device event description information, and when the operation event is press move, event input screen coordinates corresponding to each press-move event may be acquired.
c3) determining, based on the event input screen coordinates, that a drag-and-drop operation of dragging the target object in the first screen to a second screen is performed.

In this embodiment, through the event input screen coordinates corresponding to each press-move event acquired above, a press start position and each moving position point of the press-move event may be determined, so that a press-move trajectory may be determined through the press start position and the moving position points, and which object is the controlled object and the location of the controlled object may be determined, and finally, it may be determined, based on the foregoing determined information, that the drag-and-drop operation of dragging the target object in the first screen to the second screen is performed.

Specifically, in the third optional embodiment, as an implementation, determining, based on the event input screen coordinates, that a drag-and-drop operation of dragging the target object in the first screen to the second screen is performed may be further optimized as the following steps:
c31) determining, based on the event input screen coordinates, a press start coordinate and a moving coordinate sequence of the press move.

In this embodiment, the event input screen coordinates are coordinate information of each operation event being a press-move event, and through the coordinate information, it may be determined where the press operation is specifically performed, and which moving coordinate points are specifically generated in the press-move process, and therefore, the moving coordinate sequence may be generated based on the moving coordinate points, and coordinates of a first press operation may be recorded as the press start coordinate.
c32) determining, based on the press start coordinate, that a press operation is performed on the target object in the first screen.

In this embodiment, it may be considered that the controlled device uses a coordinate system including a plurality of screens as a screen coordinate system, and therefore, a location area of each screen in the screen coordinate system may be determined. In this step, it may be determined which screen the press start coordinate falls into and which controlled object on the screen the press start coordinate specifically corresponds to. In this step, the screen into which the press start coordinate falls may be determined as the first screen, and the controlled object touched by the press start coordinate is determined as the target object, and finally, it is determined that the press operation is performed on the target object in the first screen.
c33) determining, based on the moving coordinate sequence, that a drag-and-drop operation of moving the target object from the first screen to a second screen is performed.

In this embodiment, the moving coordinate sequence may be considered as a coordinate sequence of moving coordinates generated when the target object is pressed and moved, and the press-move trajectory of the target object may be determined based on the moving coordinates in the moving coordinate sequence. In this embodiment, coordinates corresponding to press-up after the target object is moved may be determined as end coordinates, and a screen in which the end coordinates are located is determined as the second screen, and finally, it may be determined through this step that the drag-and-drop operation of moving the target object from the first screen to the second screen is performed.

The technical solutions of this embodiment implement parsing and determination of the drag-and-drop operation, and related information of the drag-and-drop operation provides data support for subsequent response to the drag-and-drop operation.

FIG. 4 is a schematic diagram of a structure of an interaction control apparatus according to an embodiment of the present disclosure. This embodiment may be applied to a case of interaction control. The apparatus may be implemented in software and/or hardware, and may be configured on an electronic device as a controlling device. The electronic device may be preferably a virtual reality device. Specifically, the electronic device as the controlling device is in wireless communication with a controlled device, and the controlled device includes at least two screens. The apparatus may specifically include: a window display module 41, an information sending module 42, and a content display module 43.

The window display module 41 is configured to display at least two window interfaces in an interaction control scenario, where each window interface corresponds to one screen of the controlled device, and present screen content in the corresponding screen; the information sending module 42 is configured to monitor an input event generated by an input device, generate input event information of the input event, and send the input event information to the controlled device, so that the controlled device determines, based on the input event information, that a drag-and-drop operation is performed on a target object, where the input event is generated when an indication cursor of the input device moves from a first window interface to a second window interface; and the content display module 43 is configured to receive and display image content fed back by the controlled device, where the image content is that the target object is dragged and dropped from a first screen to a second screen, and the first screen and the second screen correspond to the first window interface and the second window interface, respectively.

The interaction control apparatus provided in this embodiment provides a complete reception implementation of acquiring an output event generated when the input device is moved from one window interface to another window interface. Different from the prior art in which only an input event generated in one window interface may be received, the above solution in this embodiment better ensures the integrity of the received input event, and also ensures simplification of an operation event at an operation level. This embodiment provides basic data support for subsequent flexible cross-screen dragging of the controlled object.

Further, the information sending module 42 may include: an event monitoring unit, where the event monitoring unit may be further configured to: monitor, by calling an input reception function, the indication cursor of the input device, where the input reception function is constructed in an operating system on which the controlling device depends, and the input reception function is constructed in association with the interaction control scenario; receive a first input event generated by the input device when the indication cursor is in the first window interface; and receive continuously a second input event generated by the input device when the indication cursor is moved out of the first window interface to the second window interface.

Further, the input reception function is constructed in a function library of the operating system, and the input reception function defines a code description for establishing an association with the interaction control scenario; and the input reception function is called and started to run through a set input call interface after the wireless connection is established.

Further, the information sending module 42 may further include: an information generation unit, where the information generation unit may specifically include: an acquisition subunit, configured to acquire event attribute information corresponding to the input event, where the event attribute information includes: original event input coordinates and a press state; and a determination subunit, configured to determine, based on preset first event mapping information and the event attribute information, the input event information corresponding to the input event.

Further, the determination subunit may be further configured to: determine an operation event represented by the input event based on the original event input coordinates and the press state; and generate event description information of the operation event based on the first event mapping information, and use the event description information as the input event information.

The interaction control apparatus provided in this embodiment of the present disclosure may perform the interaction control method provided in any embodiment of the present disclosure, and has function modules and beneficial effects corresponding to the method performed.

It should be noted that the units and modules included in the above apparatus are only divided according to functional logic, but are not limited to the above division, as long as the corresponding functions may be implemented. In addition, the specific names of the functional units are only for the convenience of distinguishing from each other, and are not used to limit the protection scope of the embodiments of the present disclosure.

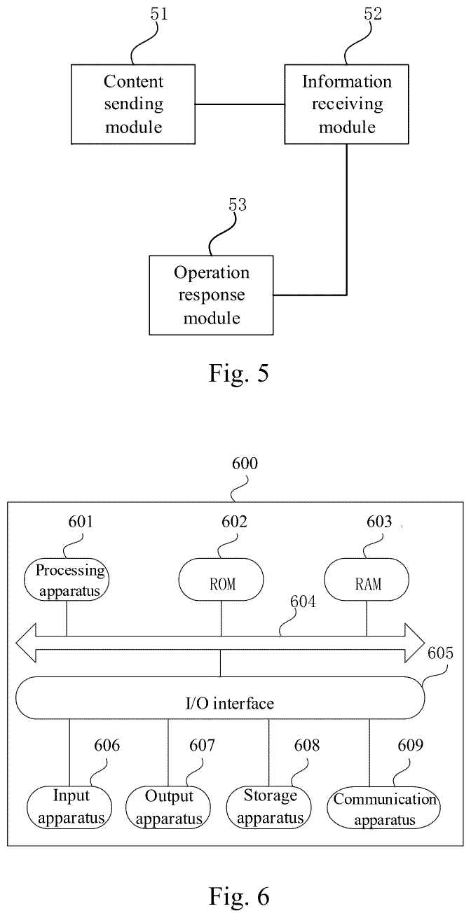

FIG. 5 is a schematic diagram of a structure of an interaction control apparatus according to an embodiment of the present disclosure. This embodiment may be applied to a case of interaction control. The apparatus may be implemented in software and/or hardware, and may be configured on an electronic device as a controlled device. The electronic device may be a mobile terminal, a PC, a server, etc. Specifically, the controlled device may establish a wireless connection with a controlling device, and at least two screens may be configured on the controlled device as the execution body of this embodiment. The apparatus may specifically include: a content sending module 51, an information receiving module 52, and an operation response module 53.

The content sending module 51 is configured to send screen content in each of the screens to the controlling device in an interaction control scenario, to display, on the controlling device, at least two window interfaces, where each of the window interfaces corresponds to one screen, and present screen content in a corresponding screen; the information receiving module 52 is configured to receive input event information sent by the controlling device, and determine, based on the input event information, that a drag-and-drop operation is performed on a target object, where the input event information is generated by the controlling device by monitoring an input event of an input device; and the operation response module 53 is configured to respond to the drag-and-drop operation, and feed back image content generated in the response to the drag-and-drop operation to the controlling device, so that the controlling device receives and displays the image content, where the image content is that the target object is dragged and dropped from a first screen to a second screen, and the first screen and the second screen correspond to a first window interface and a second window interface on the controlling device, respectively.

The interaction control apparatus provided in this embodiment specifically provides a real-time response process of a press-move event when the controlled device side performs press move across the windows through the controlling device side. In the above embodiments, it is ensured that the controlling device may continuously receive input events generated across the windows without interrupting the reception of the input events when the input device is moved out of one window to another window. On this basis, it is ensured that the controlled device may also continuously respond to operation instructions corresponding to the input events, thereby ensuring cross-screen drag-and-drop control of a manipulated object on the controlled device by the controlling device, simplifying the existing cross-screen dragging that requires multiple interactions to achieve, improving input control flexibility of the controlling device, and also improving operation experience of an operator.

Further, the information receiving module 52 may specifically include: a mapping conversion unit, configured to convert, based on preset second event mapping information, the input event information into parsable device event description information; a parsing unit, configured to parse the device event description information, determine an operation event corresponding to the input event as press move, and acquire event input screen coordinates involved in the press move; and a drag-and-drop determination unit, configured to determine, based on the event input screen coordinates, that a drag-and-drop operation of dragging the target object in the first screen to the second screen is performed.

Further, the drag-and-drop determination unit may be further configured to: determine, based on the event input screen coordinates, a press start coordinate and a moving coordinate sequence of the press move; determine, based on the press start coordinate, that a press operation is performed on the target object in the first screen; and determine, based on the moving coordinate sequence, that a drag-and-drop operation of moving the target object from the first screen to the second screen is performed.

The interaction control apparatus provided in this embodiment of the present disclosure may perform the interaction control method provided in any embodiment of the present disclosure, and has function modules and beneficial effects corresponding to the method performed.

It should be noted that the units and modules included in the above apparatus are only divided according to functional logic, but are not limited to the above division, as long as the corresponding functions may be implemented. In addition, the specific names of the functional units are only for the convenience of distinguishing from each other, and are not used to limit the protection scope of the embodiments of the present disclosure.

FIG. 6 is a schematic diagram of a structure of a virtual reality device according to an embodiment of the present disclosure. Reference is made to FIG. 6 below, which is a schematic diagram of a structure of a virtual reality device 600 suitable for implementing the embodiments of the present disclosure. The virtual reality device in this embodiment of the present disclosure may include, but is not limited to, a wearable smart device such as a head-mounted device and virtual reality glasses. The virtual reality device shown in FIG. 6 is only an example, and should not impose any limitation on the function and scope of use of the embodiments of the present disclosure.

As shown in FIG. 6, the virtual reality device 600 may include a processing apparatus (such as a central processing unit and a graphics processor) 601, which may perform various appropriate actions and processing based on a program stored in a read-only memory (ROM) 602 or a program loaded from a storage apparatus 608 into a random access memory (RAM) 603. The RAM 603 further stores various programs and data required for operations of the virtual reality device 600. The processing apparatus 601, the ROM 602, and the RAM 603 are connected to each other through a bus 604. An editing/output (I/O) interface 605 is also connected to the bus 604.

Usually, the following apparatuses may be connected to the I/O interface 605: an input apparatus 606 including, for example, a Bluetooth mouse, a handle, a gesture, a camera, a microphone, an accelerometer, and a gyroscope; an output apparatus 607 including, for example, a liquid crystal display (LCD), a speaker, and a vibrator; a storage apparatus 608 including, for example, a magnetic tape and a hard disk; and a communication apparatus 609. The communication apparatus 609 may allow the virtual reality device 600 to perform wireless or wired communication with other devices to exchange data. Although FIG. 6 shows the virtual reality device 600 having various apparatuses, it should be understood that it is not required to implement or have all the shown apparatuses. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program code for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the foregoing functions limited in the method of the embodiments of the present disclosure are performed.

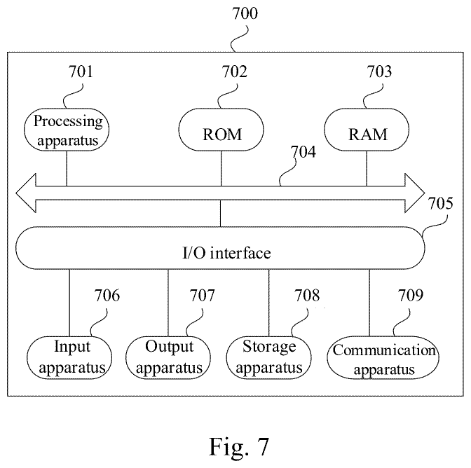

FIG. 7 is a schematic diagram of a structure of an electronic device according to an embodiment of the present disclosure. Reference is made to FIG. 7 below, which is a schematic diagram of a structure of an electronic device (such as a terminal device or a server in FIG. 7) 700 suitable for implementing the embodiments of the present disclosure. The terminal device in this embodiment of the present disclosure may include, but is not limited to, a mobile terminal such as a mobile phone, a notebook computer, a digital broadcast receiver, a PDA (personal digital assistant), a PAD (tablet computer), a PMP (portable multimedia player), and a vehicle-mounted terminal (such as a vehicle navigation terminal), and a fixed terminal such as a digital TV and a desktop computer. The electronic device shown in FIG. 7 is only an example, and should not impose any limitation on the function and scope of use of the embodiments of the present disclosure.

As shown in FIG. 7, the electronic device 700 may include a processing apparatus (such as a central processing unit and a graphics processor) 701, which may perform various appropriate actions and processing based on a program stored in a read-only memory (ROM) 702 or a program loaded from a storage apparatus 708 into a random access memory (RAM) 703. The RAM 703 further stores various programs and data required for operations of the electronic device 700. The processing apparatus 701, the ROM 702, and the RAM 703 are connected to each other through a bus 704. An editing/output (I/O) interface 705 is also connected to the bus 704.

Usually, the following apparatuses may be connected to the I/O interface 705: an input apparatus 706 including, for example, a touch screen, a touchpad, a keyboard, a mouse, a camera, a microphone, an accelerometer, and a gyroscope; an output apparatus 707 including, for example, a liquid crystal display (LCD), a speaker, and a vibrator; a storage apparatus 708 including, for example, a magnetic tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all the shown apparatuses. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program code for performing the method shown in the flowchart. In such an embodiment, the computer program may be downloaded and installed from a network through the communication apparatus 709, or installed from the storage apparatus 708, or installed from the ROM 702. When the computer program is executed by the processing apparatus 701, the foregoing functions limited in the method of the embodiments of the present disclosure are performed.

The names of messages or information exchanged between a plurality of apparatuses in the implementations of the present disclosure are only for illustrative purposes, and are not intended to limit the scope of these messages or information.

The electronic device provided in this embodiment of the present disclosure belongs to the same inventive concept as the interaction control method provided in the above embodiments. For the technical details not described in detail in this embodiment, reference may be made to the above embodiments, and this embodiment has the same beneficial effects as the above embodiments.

An embodiment of the present disclosure provides a computer storage medium having a computer program stored thereon, where the program, when executed by a processor, implements the interaction control method provided in the above embodiments.

It should be noted that the foregoing computer-readable medium in the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus, device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that includes or stores a program, and the program may be used by or used in combination with an instruction execution system, apparatus, or device. In the present disclosure, the computer-readable signal medium may include a data signal propagated on a baseband or as a part of a carrier, and computer-readable program code is carried in the data signal. The data signal propagated in this manner may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including but not limited to a wire, an optical cable, a radio frequency (RF), or any suitable combination thereof.

In some implementations, a client and a server may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The computer-readable medium may be contained in the electronic device, or may exist alone without being assembled into the electronic device.

The computer-readable medium carries one or more programs, and when the one or more programs are executed by the electronic device, the electronic device: displaying at least two window interfaces in an interaction control scenario, where each window interface corresponds to one screen of the at least two screens of the controlled device, and presenting screen content in a corresponding screen; monitoring an input event generated by an input device, generating input event information of the input event, and sending the input event information to the controlled device, so that the controlled device determines, based on the input event information, that a drag-and-drop operation is performed on a target object, where the input event is generated when an indication cursor of the input device moves from a first window interface to a second window interface; and receiving and displaying image content fed back by the controlled device, where the image content is that the target object is dragged and dropped from a first screen to a second screen, and the first screen and the second screen correspond to the first window interface and the second window interface, respectively.

The computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user through any type of network, including a local area network (LAN) or a wide area network (WAN), or may be connected to an external computer (for example, connected through the Internet with the aid of an Internet service provider).

The flowchart and block diagrams in the drawings illustrate the architecture, functionality, and operation of possible implementations of the systems, methods and computer program products according to various embodiments of the present disclosure. In this regard, each block in the flowchart or block diagrams may represent a module, a program segment, or a portion of code that includes one or more executable instructions for implementing a specified logical function. Furthermore, it should be noted that, in some alternative implementations, functions indicated in the blocks may occur in an order different from that indicated in the drawings. For example, two blocks shown in succession may, in fact, be executed substantially concurrently, or the blocks may sometimes be executed in a reverse order, depending upon the functionality involved. It also should be noted that each block of the block diagrams and/or flowchart, or a combination of blocks in the block diagrams and/or flowchart may be implemented in a special purpose hardware-based system that perform a specified function or operation, or may be implemented in a combination of special purpose hardware and a computer instruction.

The involved units described in the embodiments of the present disclosure may be implemented by means of software, and may also be implemented by means of hardware. The name of a unit does not constitute a limitation on the unit itself under certain circumstances.

The functions described herein above may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD) and more.

In the context of the present disclosure, a machine-readable medium may be a tangible medium that may include or store a program to be used by or in combination with an instruction execution system, apparatus or device. The machine-readable medium may be a machine-readable signal medium or a machine-readable storage medium. The machine-readable medium includes, but is not limited to, an electronic, magnetic, optical, electromagnetic, infrared, or semi-conductive system, apparatus or device, or any suitable combination of the above. More specific examples of the machine-readable storage medium would include an electrical connection on the basis of one or more wires, a portable computer disk, a hard disk, a random access memory (RAM), a read only memory (ROM), an erasable programmable read only memory (EPROM or flash memory), an optical fiber, a portable compact disc read-only memory (CD-ROM), an optical storage device, a magnetic storage device, or any suitable combination of the above.

According to one or more embodiments of the present disclosure, [Example 1] provides an interaction control method, which is applied to a controlling device, where the controlling device is in wireless communication with a controlled device, the controlled device includes at least two screens, and the method includes: displaying at least two window interfaces in an interaction control scenario, where each window interface corresponds to one screen of the controlled device, and presenting screen content in the corresponding screen; monitoring an input event generated by an input device, generating input event information of the input event, and sending the input event information to the controlled device, so that the controlled device determines, based on the input event information, that a drag-and-drop operation is performed on a target object, where the input event is generated when an indication cursor of the input device moves from a first window interface to a second window interface; and receiving and displaying image content fed back by the controlled device, where the image content is that the target object is dragged and dropped from a first screen to a second screen, and the first screen and the second screen correspond to the first window interface and the second window interface, respectively.

According to one or more embodiments of the present disclosure, [Example 2] provides the method of Example 1, and further includes: optionally, monitoring an input event generated by an input device and generating input event information of the input event includes: monitoring, by calling an input reception function, the indication cursor of the input device, where the input reception function is constructed in an operating system on which the controlling device depends, and the input reception function is constructed in association with the interaction control scenario; receiving a first input event generated by the input device when the indication cursor is in the first window interface; and receiving continuously a second input event generated by the input device when the indication cursor is moved out of the first window interface to the second window interface.

According to one or more embodiments of the present disclosure, [Example 3] provides the method of Example 1, and further includes: optionally, the input reception function is constructed in a function library of the operating system, and the input reception function defines a code description for establishing an association with the interaction control scenario; and the input reception function is called and started to run through a set input call interface after the wireless connection is established.

According to one or more embodiments of the present disclosure, [Example 4] provides the method of Example 1, and further includes: optionally, generating input event information of the input event includes: acquiring event attribute information corresponding to the input event, where the event attribute information includes: original event input coordinates and a press state; and determining, based on preset first event mapping information and the event attribute information, the input event information corresponding to the input event.

According to one or more embodiments of the present disclosure, [Example 5] provides the method of Example 4, and further includes: optionally, determining, based on preset first event mapping information and the event attribute information, the input event information corresponding to the input event includes: determining an operation event represented by the input event based on the original event input coordinates and the press state; and generating event description information of the operation event based on the first event mapping information, and using the event description information as the input event information.

According to one or more embodiments of the present disclosure, [Example 6] provides the method of Example 1, and further includes: optionally, the controlling device is a virtual reality device; the input device is a handle, and the indication cursor is a handle ray; or the input device is a gesture detection device, and the indication cursor is a gesture icon; or the input device is a mouse, and the indication cursor is a mouse arrow.

According to one or more embodiments of the present disclosure, [Example 7] provides an interaction control method, which is applied to a controlled device, where the controlled device is in wireless communication with a controlling device, the controlled device includes at least two screens, and the method includes: sending screen content in each of the screens to the controlling device in an interaction control scenario, to display, on the controlling device, at least two window interfaces, where each of the window interfaces corresponds to one screen, and present screen content in a corresponding screen; receiving input event information sent by the controlling device, and determining, based on the input event information, that a drag-and-drop operation is performed on a target object, where the input event information is generated by the controlling device by monitoring an input event of an input device; and responding to the drag-and-drop operation, and feeding back image content generated in the response to the drag-and-drop operation to the controlling device, so that the controlling device receives and displays the image content, where the image content is that the target object is dragged and dropped from a first screen to a second screen, and the first screen and the second screen correspond to a first window interface and a second window interface on the controlling device, respectively.

According to one or more embodiments of the present disclosure, [Example 8] provides the method of Example 7, and further includes: optionally, determining, based on the input event information, that a drag-and-drop operation is performed on the target object includes: converting, based on preset second event mapping information, the input event information into parsable device event description information; parsing the device event description information, determining an operation event corresponding to the input event as press move, and acquiring event input screen coordinates involved in the press move; and determining, based on the event input screen coordinates, that a drag-and-drop operation of dragging the target object in the first screen to the second screen is performed.

According to one or more embodiments of the present disclosure, [Example 9] provides the method of Example 8, and further includes: optionally, determining, based on the event input screen coordinates, that a drag-and-drop operation of dragging the target object in the first screen to the second screen is performed includes:
determining, based on the event input screen coordinates, a press start coordinate and a moving coordinate sequence of the press move;
determining, based on the press start coordinate, that a press operation is performed on the target object in the first screen; and
determining, based on the moving coordinate sequence, that a drag-and-drop operation of moving the target object from the first screen to the second screen is performed.

According to one or more embodiments of the present disclosure, [Example 10] provides an interaction control apparatus, which is configured on a controlling device, where the controlling device is in wireless communication with a controlled device, the controlled device includes at least two screens, and the apparatus includes:
a window display module, configured to display at least two window interfaces in an interaction control scenario, where each window interface corresponds to one screen of the controlled device, and present screen content in the corresponding screen;
an information sending module, configured to monitor an input event generated by an input device, generate input event information of the input event, and send the input event information to the controlled device, so that the controlled device determines, based on the input event information, that a drag-and-drop operation is performed on a target object, where the input event is generated when an indication cursor of the input device moves from a first window interface to a second window interface; and
a content display module, configured to receive and display image content fed back by the controlled device, where the image content is that the target object is dragged and dropped from a first screen to a second screen, and the first screen and the second screen correspond to the first window interface and the second window interface, respectively.

According to one or more embodiments of the present disclosure, [Example 11] provides an interaction control apparatus, which is configured on a controlled device, where the controlled device is in wireless communication with a controlling device, the controlled device includes at least two screens, and the apparatus includes:
a content sending module, configured to send screen content in each of the screens to the controlling device in an interaction control scenario, to display, on the controlling device, at least two window interfaces, where each of the window interfaces corresponds to one screen, and present screen content in a corresponding screen;
an information receiving module, configured to receive input event information sent by the controlling device, and determine, based on the input event information, that a drag-and-drop operation is performed on a target object, where the input event information is generated by the controlling device by monitoring an input event of an input device; and
an operation response module, configured to respond to the drag-and-drop operation, and feed back image content generated in the response to the drag-and-drop operation to the controlling device, so that the controlling device receives and displays the image content, where the image content is that the target object is dragged and dropped from a first screen to a second screen, and the first screen and the second screen correspond to a first window interface and a second window interface on the controlling device, respectively.

The descriptions involved in the present disclosure are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. An interaction control method, applied to a controlling device, wherein the controlling device is in wireless communication with a controlled device, the controlled device comprises at least two screens, and the method comprises:
displaying at least two window interfaces in an interaction control scenario, wherein each of the at least two window interfaces corresponds to one screen of the at least two screens of the controlled device, and presenting screen content in a corresponding screen;
monitoring an input event generated by an input device, generating input event information of the input event, and sending the input event information to the controlled device, so that the controlled device determines, based on the input event information, that a drag-and-drop operation is performed on a first object, wherein the input event is generated when an indication cursor of the input device moves from a first window interface to a second window interface; and
receiving and displaying image content fed back by the controlled device, wherein the image content is that the first object is dragged and dropped from a first screen to a second screen, and the first screen and the second screen correspond to the first window interface and the second window interface, respectively.

2. The method of claim 1, wherein the monitoring the input event generated by the input device and generating the input event information of the input event comprises:
monitoring, by calling an input reception function, the indication cursor of the input device, wherein the input reception function is constructed in an operating system that the controlling device depends on, and the input reception function is constructed in association with the interaction control scenario;
receiving a first input event generated by the input device when the indication cursor is in the first window interface; and
receiving a second input event generated by the input device when the indication cursor is moved out of the first window interface to the second window interface.

3. The method of claim 2, wherein
the input reception function is constructed in a function library of the operating system, the input reception function comprising code descriptions for establishing an association with the interaction control scenario; and
the input reception function is called and initiated via an input invocation interface upon establishment of the wireless connection.

4. The method of claim 1, wherein the generating the input event information of the input event comprises:
acquiring event attribute information corresponding to the input event, wherein the event attribute information comprises: original event input coordinates and a press state; and
determining, based on first event mapping information and the event attribute information, the input event information corresponding to the input event.

5. The method of claim 4, wherein the determining, based on the first event mapping information and the event attribute information, the input event information corresponding to the input event comprises:
determining an operation event represented by the input event based on the original event input coordinates and the press state; and
generating event description information of the operation event based on the first event mapping information, and using the event description information as the input event information.

6. The method of claim 1, wherein
the controlling device is a virtual reality device;
the input device is a handle, and the indication cursor is a handle ray.

7. The method of claim 1, wherein
the controlling device is a virtual reality device;
the input device is a gesture detection device, and the indication cursor is a gesture icon.

8. The method of claim 1, wherein
the controlling device is a virtual reality device;
the input device is a mouse, and the indication cursor is a mouse arrow.

9. An interaction control method, applied to a controlled device, wherein the controlled device is in wireless communication with a controlling device, the controlled device comprises at least two screens, and the method comprises:
sending screen content in each of the at least two screens to the controlling device in an interaction control scenario, to display, on the controlling device, at least two window interfaces, wherein each of the at least two window interfaces corresponds to one screen, and presents screen content in a corresponding screen;
receiving input event information sent by the controlling device, and determining, based on the input event information, that a drag-and-drop operation is performed on a first object, wherein the input event information is generated by the controlling device by monitoring an input event of an input device; and
responding to the drag-and-drop operation, and feeding back image content generated in a response to the drag-and-drop operation to the controlling device, so that the controlling device receives and displays the image content, wherein the image content is that the first object is dragged and dropped from a first screen to a second screen, and the first screen and the second screen correspond to a first window interface and a second window interface on the controlling device, respectively.

10. The method of claim 9, wherein the determining, based on the input event information, that the drag-and-drop operation is performed on the first object comprises:
converting, based on second event mapping information, the input event information into parsable device event description information;
parsing the device event description information, determining an operation event corresponding to the input event as press move, and acquiring event input screen coordinates involved in the press move; and
determining, based on the event input screen coordinates, that a drag-and-drop operation of dragging the first object in the first screen to the second screen is performed.

11. The method of claim 10, wherein the determining, based on the event input screen coordinates, that the drag-and-drop operation of dragging the first object in the first screen to the second screen is performed comprises:
determining, based on the event input screen coordinates, a press start coordinate and a moving coordinate sequence of the press move;
determining, based on the press start coordinate, that a press operation is performed on the first object in the first screen; and
determining, based on the moving coordinate sequence, that a drag-and-drop operation of moving the first object from the first screen to the second screen is performed.

12. An electronic device, comprising:
one or more input devices;
one or more processors; and
a storage apparatus, configured to store one or more programs,
wherein the one or more programs are executed by the one or more processors, so that the one or more processors implement an interaction control method, and the method comprises:
displaying at least two window interfaces in an interaction control scenario, wherein each of the at least two window interfaces corresponds to one screen of the at least two screens of the controlled device, and presenting screen content in a corresponding screen;
monitoring an input event generated by an input device, generating input event information of the input event, and sending the input event information to the controlled device, so that the controlled device determines, based on the input event information, that a drag-and-drop operation is performed on a first object, wherein the input event is generated when an indication cursor of the input device moves from a first window interface to a second window interface; and
receiving and displaying image content fed back by the controlled device, wherein the image content is that the first object is dragged and dropped from a first screen to a second screen, and the first screen and the second screen correspond to the first window interface and the second window interface, respectively.

13. The electronic device of claim 12, wherein the electronic device is a virtual reality device.

14. The electronic device of claim 12, wherein the monitoring the input event generated by the input device and generating the input event information of the input event comprises:
monitoring, by calling an input reception function, the indication cursor of the input device, wherein the input reception function is constructed in an operating system that the controlling device depends on, and the input reception function is constructed in association with the interaction control scenario;
receiving a first input event generated by the input device when the indication cursor is in the first window interface; and
receiving a second input event generated by the input device when the indication cursor is moved out of the first window interface to the second window interface.

15. The electronic device of claim 14, wherein
the input reception function is constructed in a function library of the operating system, the input reception function comprising code descriptions for establishing an association with the interaction control scenario; and
the input reception function is called and initiated via an input invocation interface upon establishment of the wireless connection.

16. The electronic device of claim 12, wherein the generating the input event information of the input event comprises:
acquiring event attribute information corresponding to the input event, wherein the event attribute information comprises: original event input coordinates and a press state; and
determining, based on first event mapping information and the event attribute information, the input event information corresponding to the input event.

17. The electronic device of claim 16, wherein the determining, based on the first event mapping information and the event attribute information, the input event information corresponding to the input event comprises:
determining an operation event represented by the input event based on the original event input coordinates and the press state; and
generating event description information of the operation event based on the first event mapping information, and using the event description information as the input event information.

18. An electronic device, comprising:
one or more processors; and
a storage apparatus, configured to store one or more programs,
wherein the one or more programs are executed by the one or more processors, so that the one or more processors implement the interaction control method of claim 7.

19. The electronic device of claim 18, wherein the determining, based on the input event information, that the drag-and-drop operation is performed on the first object comprises:
converting, based on second event mapping information, the input event information into parsable device event description information;
parsing the device event description information, determining an operation event corresponding to the input event as press move, and acquiring event input screen coordinates involved in the press move; and
determining, based on the event input screen coordinates, that a drag-and-drop operation of dragging the first object in the first screen to the second screen is performed.

20. A non-transitory storage medium comprising computer-executable instructions, wherein the computer-executable instructions, when executed by a computer processor, cause the computer processor to perform the interaction control method of claim 1.
